(19) United States
(12) Patent Application Publication
(10) Pub. No.: US 2025/0264838 A1
(43) Pub. Date: Aug. 21, 2025

(54) REMAINING AMOUNT PREDICTION SYSTEM SWITCHING PREDICTION METHOD TO BE USED TO PREDICT EMPTY DAY AND COMPUTER-READABLE NON-TRANSITORY RECORDING MEDIUM STORING REMAINING AMOUNT PREDICTION PROGRAM

(71) Applicant: KYOCERA Document Solutions Inc., Osaka (JP)

(72) Inventors: Atsushi SUZUKI, Osaka (JP); Kyoichiro HAYASHI, Osaka (JP); Hisakazu NISHIYAMA, Osaka (JP); Yuya MAESONO, Osaka (JP); Kazuki DOZEN, Osaka (JP); Kosuke USUI, Osaka (JP)

(73) Assignee: KYOCERA Document Solutions Inc., Osaka (JP)

(21) Appl. No.: 19/052,676

(22) Filed: Feb. 13, 2025

(30) Foreign Application Priority Data
Feb. 19, 2024 (JP) 2024-022895

(51) Int. Cl. G03G 15/00

(52) U.S. Cl. CPC G03G 15/556

(57) ABSTRACT

A remaining amount prediction system includes a storage device and a controller. The storage device stores actual measurement value data indicating an amount of actually remaining consumable product used in an electronic device. The controller includes a processor and functions as a remaining amount predictor by the processor executing a remaining amount prediction program. The remaining amount predictor predicts an empty day when the amount of remaining consumable product will become equal to or less than a specific amount on the basis of the amount of actually remaining consumable product. The remaining amount predictor switches a prediction method to be used to predict the empty day from a linear approximation using method using linear approximation to a machine learning model using method using a machine learning model in a process in which the amount of actually remaining consumable product decreases.

### INCORPORATION BY REFERENCE

This application claims priority to Japanese Patent Application No. 2024-022895 filed on 19 Feb. 2024, the entire contents of which are incorporated by reference herein.

### BACKGROUND

The present disclosure relates to a remaining amount prediction system predicting the amount of remaining consumable product used in an electronic device and a computer-readable non-transitory recording medium storing a remaining amount prediction program.

Typically, a remaining amount prediction system that predicts the amount of remaining consumable product used in an electronic device using a machine learning model is known.

For example, the typical remaining amount prediction system uses a machine learning model that predicts the amount of toner that will remain one day later than the latest date among dates corresponding to the amounts of remaining consumable products during one or more days that are the basis of explanatory variables to be input to the machine learning model.

Such a typical remaining amount prediction system predicts the amount of consumable product remaining one day later than the latest date indicated by actual measurement value data by first inputting, to the machine learning model, an explanatory variable generated by the amount of remaining consumable product per day indicated by the actual measurement value data indicating a value obtained by measuring the amount of remaining consumable product in the electronic device once a day to predict the day when the amount of remaining consumable product will become equal to or less than a specific amount.

Then, the amount of consumable product remaining two days later than the latest date indicated by the actual measurement value data is predicted by inputting, to the machine learning model, an explanatory variable generated on the basis of the amount of consumable product remaining on each day indicated by the actual measurement value data and the amount of consumable product remaining one day later than the latest date indicated by the actual measurement value data that has already been predicted.

Then, the amount of consumable product remaining three days later than the latest date indicated by the actual measurement value data is predicted by inputting, to the machine learning model, an explanatory variable generated on the basis of the amount of consumable product remaining on each day indicated by the actual measurement value data and the amounts of consumable product remaining one day later and two days later than the latest date indicated by the actual measurement value data that have already been predicted.

The typical remaining amount prediction system predicts the day when the amount of remaining consumable product will become equal to or less than a specific amount by repeating the operations described above.

### SUMMARY

As an aspect of the present disclosure, a technology achieved by further improving the above technology will be proposed.

A remaining amount prediction system according to an aspect of the present disclosure includes a storage device and a controller. The storage device stores actual measurement value data indicating an amount of actually remaining consumable product used in an electronic device. The controller includes a processor and functions as a remaining amount predictor by the processor executing a remaining amount prediction program. The remaining amount predictor predicts an empty day when the amount of remaining consumable product will become equal to or less than a specific amount on the basis of the amount of actually remaining consumable product. The remaining amount predictor switches a prediction method to be used to predict the empty day from a linear approximation using method using linear approximation to a machine learning model using method using a machine learning model in a process in which the amount of actually remaining consumable product decreases.

A computer-readable non-transitory recording medium according to another aspect of the present disclosure stores a remaining amount prediction program. The remaining amount prediction program causes a computer including a processor and a storage device that stores actual measurement value data indicating an amount of actually remaining consumable product used in an electronic device to function as a remaining amount predictor by the processor executing the remaining amount prediction program. The remaining amount predictor predicts an empty day when the amount of remaining consumable product will become equal to or less than a specific amount on the basis of the amount of actually remaining consumable product. The remaining amount predictor switches a prediction method to be used to predict the empty day from a linear approximation using method using linear approximation to a machine learning model using method using a machine learning model in a process in which the amount of actually remaining consumable product decreases.

### BRIEF DESCRIPTION OF THE DRAWINGS

FIG. 1 is a block diagram of a system according to an embodiment of the present disclosure.

FIG. 2 is a block diagram illustrating an example of a configuration of a remaining amount prediction system.

FIG. 3 is a diagram illustrating an example of the amount of toner remaining on each day indicated by actual measurement value data.

FIG. 4 is a block diagram illustrating an example of a configuration of an image forming apparatus.

FIG. 5 is a sequence diagram illustrating operations of the system in a case where a toner container that is a new product has been set in the image forming apparatus.

FIG. 6 is a sequence diagram illustrating operations of the system in a case where the remaining amount prediction system records an actual measurement value of the amount of toner remaining in the image forming apparatus.

FIG. 7 is a flowchart illustrating an example of operations of the remaining amount prediction system in a case where a toner empty day is predicted.

FIG. 8 is an explanatory diagram of an empty day prediction method using linear approximation.

FIG. 9 is a flowchart illustrating prediction processing using a machine learning model.

FIG. 10 is a flowchart illustrating another example of operations of the remaining amount prediction system in a case where a toner empty day is predicted.

### DETAILED DESCRIPTION

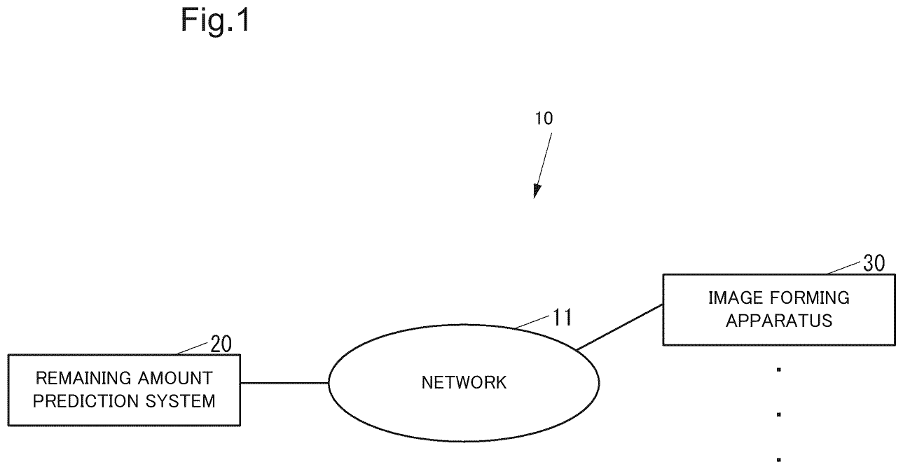

Hereinafter, an embodiment of the present disclosure will be described using the drawings. First, a configuration of a system according to an embodiment of the present disclosure will be described. FIG. 1 is a block diagram of a system 10 according to the present embodiment.

As illustrated in FIG. 1, the system 10 includes a remaining amount prediction system 20. The remaining amount prediction system 20 predicts the amount of remaining toner as a consumable product used in an image forming apparatus as an electronic device. The remaining amount prediction system 20 may be configured by one computer such as a personal computer or may be configured by a plurality of computers. The remaining amount prediction system 20 may be configured on a cloud.

The system 10 includes an image forming apparatus 30. The image forming apparatus 30 is, for example, a multifunction peripheral (MFP), a printer dedicated device, or the like. The system 10 can include at least another image forming apparatus 30 with a configuration similar to that of the image forming apparatus 30 in addition to the image forming apparatus 30.

The remaining amount prediction system 20 and the image forming apparatus 30 can communicate with each other via a network 11 such as a local area network (LAN) or the Internet, for example.

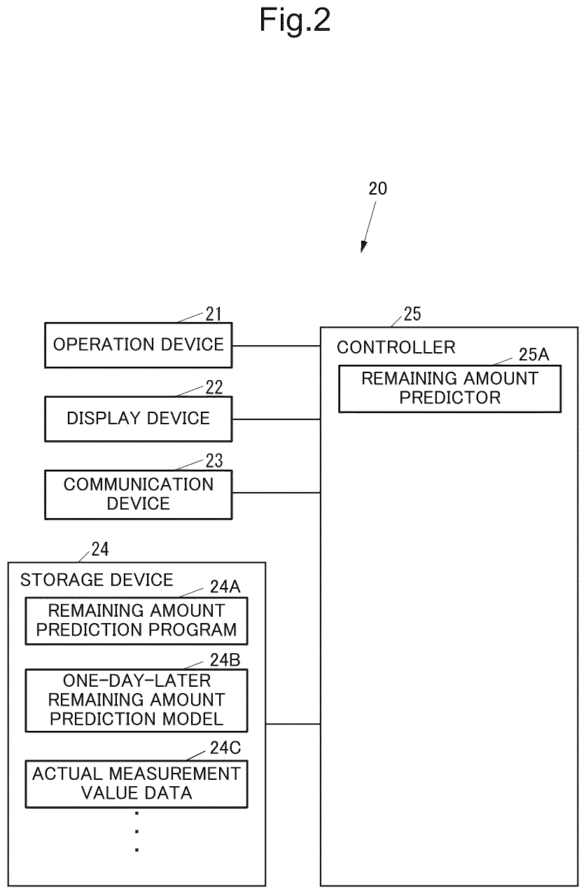

FIG. 2 is a block diagram illustrating a configuration of the remaining amount prediction system 20 configured by one computer. As illustrated in FIG. 2, the remaining amount prediction system 20 includes an operation device 21, a display device 22, a communication device 23, a storage device 24, and a controller 25.

The operation device 21 is an operation device such as a keyboard or a mouse, for example, to which various commands corresponding to various operations are input. The display device 22 is a display device such as a liquid crystal display (LCD), for example, that displays various kinds of information. The communication device 23 is a communication device that communicates with an external device via a network such as a LAN or the Internet or directly in a wired or wireless manner without intervention of a network. The storage device 24 is a nonvolatile storage device such as a semiconductor memory or a hard disk drive (HDD), for example, that stores various kinds of information. The controller 25 controls operations of the entire remaining amount prediction system 20.

The storage device 24 can store a remaining amount prediction program 24A to predict the amount of toner remaining in the image forming apparatus 30. The remaining amount prediction program 24A may be installed in the remaining amount prediction system 20 in a fabrication stage of the remaining amount prediction system 20, or may be additionally installed in the remaining amount prediction system 20 from an external storage medium such as a universal serial bus (USB) memory, or may be additionally installed in the remaining amount prediction system 20 from a network, for example.

The storage device 24 can store a one-day-later remaining amount prediction model 24B. The one-day-later remaining amount prediction model 24B is a machine learning model that predicts the amount of toner remaining one day later than the reference latest date as the latest date among dates corresponding to the amounts of remaining toner during one or more days as a basis of explanatory variables to be input to the machine learning model. A gradient boosting decision tree (GBDT) is used for learning and prediction of the one-day-later remaining amount prediction model 24B. The GBDT is a method of performing prediction by combining a plurality of “decision trees” (ensemble).

The explanatory variables of the one-day-later remaining amount prediction model 24B are 9 types, namely the amount of toner remaining on the reference latest date, the amount of toner remaining one day earlier than the reference latest date, the amount of toner remaining two days earlier than the reference latest date, the amount of toner remaining three days earlier than the reference latest date, the amount of toner remaining four days earlier than the reference latest date, the amount of toner remaining five days earlier than the reference latest date, the amount of toner remaining six days earlier than the reference latest date, the amount of toner thirteen days earlier than the reference latest date, and the amount of toner remaining eighty nine days earlier than the reference latest date, for example.

The amounts of toner remaining on dates that are too earlier than the reference latest date have small influences on prediction of the amount of toner remaining one day later than the reference latest date and may thus be omitted from the explanatory variables to reduce a processing load to predict the amount of toner remaining one day later than the reference latest date. The one-day-later remaining amount prediction model 24B can predict the amount of toner remaining one day later than the reference latest date if at least one type of explanatory variable including the amount of toner remaining on the reference latest date is input from among the aforementioned nine types of explanatory variables.

The storage device 24 can store actual measurement value data 24C indicating the values of the amount of toner remaining in the image forming apparatus 30 actually measured every day. Similarly, the storage device 24 can store, for each image forming apparatus 30, the actual measurement value data indicating the values of the amount of toner remaining in the image forming apparatus 30 actually measured every day.

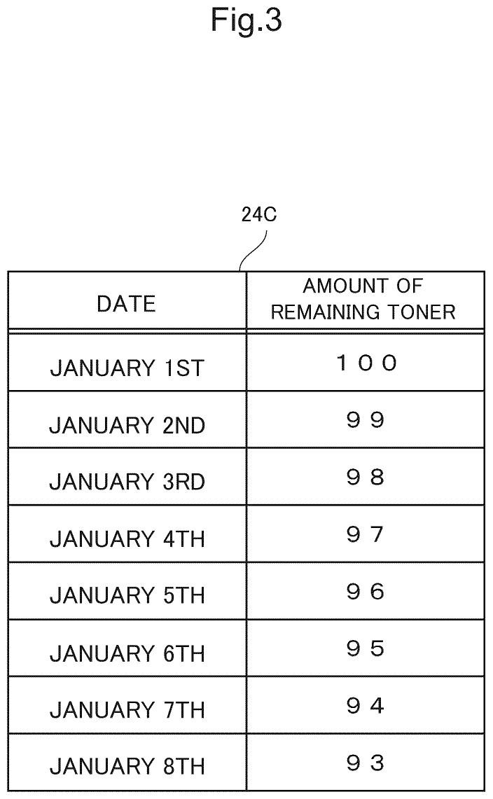

FIG. 3 is a diagram illustrating an example of the amount of toner remaining on each day indicated by the actual measurement value data 24C. As illustrated in FIG. 3, the actual measurement value data 24C indicates the date and the value of actually measured amount of remaining toner for each day. In the example illustrated in FIG. 3, the actual measurement value data 24C indicates the values of actually measured amounts of remaining toner for eight days from January 1st to January 8th. The amounts of remaining toner are represented as percentages indicated by integers from one hundred to zero.

Referring back to FIG. 2, the controller 25 includes, for example, a central processing unit (CPU), a read only memory (ROM), and a random access memory (RAM).

The ROM stores a program and various kinds of data. The RAM is a memory used as a work area of the CPU of the controller 25. The CPU of the controller 25 executes the program stored in the storage device 24 or the ROM of the controller 25.

The controller 25 realizes the remaining amount predictor 25A that predicts the amount of remaining toner using the one-day-later remaining amount prediction model 24B by executing the remaining amount prediction program 24A.

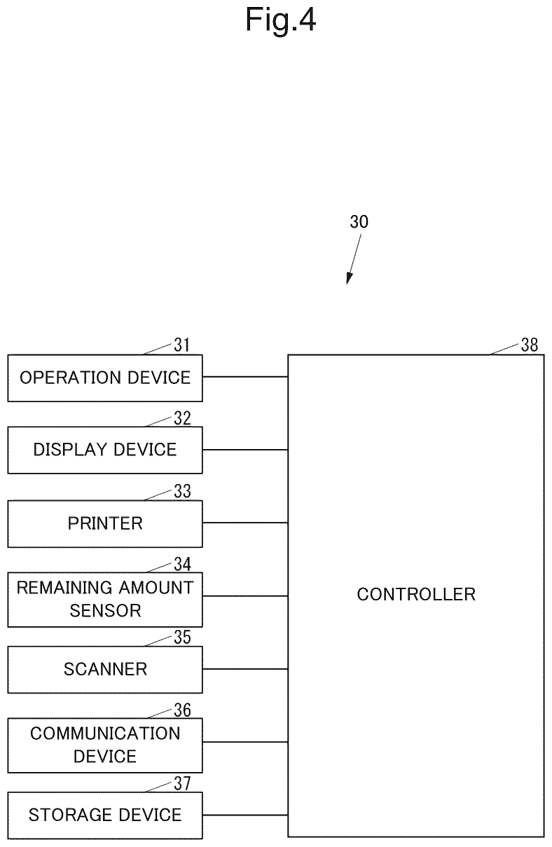

FIG. 4 is a block diagram illustrating a configuration of the image forming apparatus 30 that is an MFP. As illustrated in FIG. 4, the image forming apparatus 30 includes an operation device 31, a display device 32, a printer 33, a remaining amount sensor 34, a scanner 35, a communication device 36, a storage device 37, and a controller 38.

The operation device 31 is an operation device such as a button, for example, to which various commands corresponding to various operations are input. The display device 32 is a display device such as an LCD, for example, that displays various kinds of information. The printer 33 is a print device that prints images on recording media such as paper. The remaining amount sensor 34 detects the amount of toner remaining in a toner container where the toner to be consumed by the printer 33 is stored.

The scanner 35 is a reading device that reads images from original documents. The communication device 36 is a communication device that communicates with an external device via a network such as a LAN or the Internet or directly in a wired or wireless manner without intervention of a network. The storage device 37 is a nonvolatile storage device such as a semiconductor memory or an HDD, for example, that stores various kinds of information. The controller 38 controls operations of the entire image forming apparatus 30.

In the printer 33, replacement of the toner container is possible. The amount of remaining toner detected by the remaining amount sensor 34 becomes 100% at the timing when a used toner container is replaced with a new toner container in the image forming apparatus 30. The remaining amount sensor 34 can detect the amount of remaining toner only in a case where the amount of remaining toner is equal to or greater than 5%. In other words, the remaining amount sensor 34 cannot detect the amount of remaining toner in a case where the amount of remaining toner is less than 5%.

The controller 38 includes, for example, a CPU, a ROM, and a RAM. The ROM stores a program and various kinds of data. The RAM is a memory used as a work area of the CPU of the controller 38. The CPU of the controller 38 executes the program stored in the storage device 37 or the ROM of the controller 38.

Next, operations of the system 10 will be described. First, operations of the system 10 in a case where a new toner container has been set in the image forming apparatus 30 will be described.

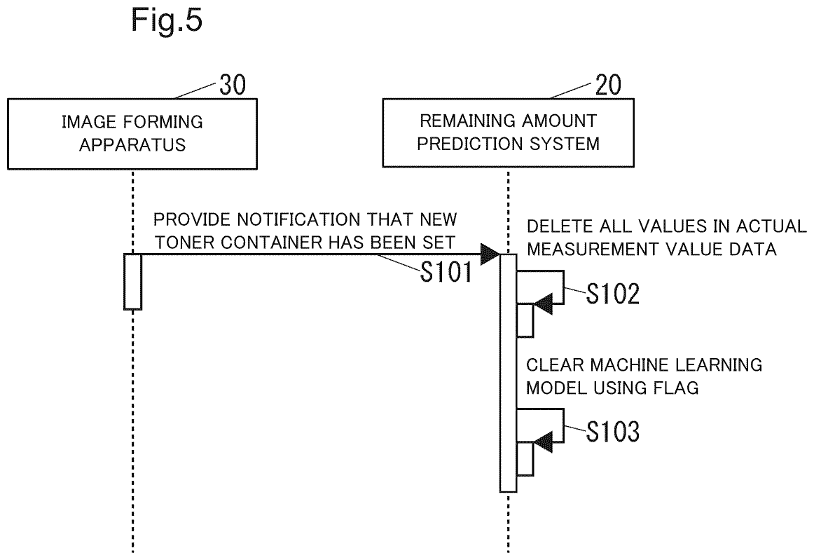

FIG. 5 is a sequence diagram illustrating operations of the system 10 in the case where a new toner container has been set in the image forming apparatus 30.

As illustrated in FIG. 5, once the new toner container is set, the image forming apparatus 30 notifies the remaining amount prediction system 20 of the fact that the new toner container has been set via the communication device 36 (Step S101).

Once the remaining amount predictor 25A of the remaining amount prediction system 20 receives the notification indicating that the new toner container has been set from the image forming apparatus 30 via the communication device 23, the remaining amount predictor 25A deletes all values in the actual measurement value data 24C (Step S102).

Once the remaining amount predictor 25A ends the processing in Step S102, the remaining amount predictor 25A clears a machine learning model using flag as a flag indicating that the amount of remaining toner will be predicted using a machine learning model (Step S103).

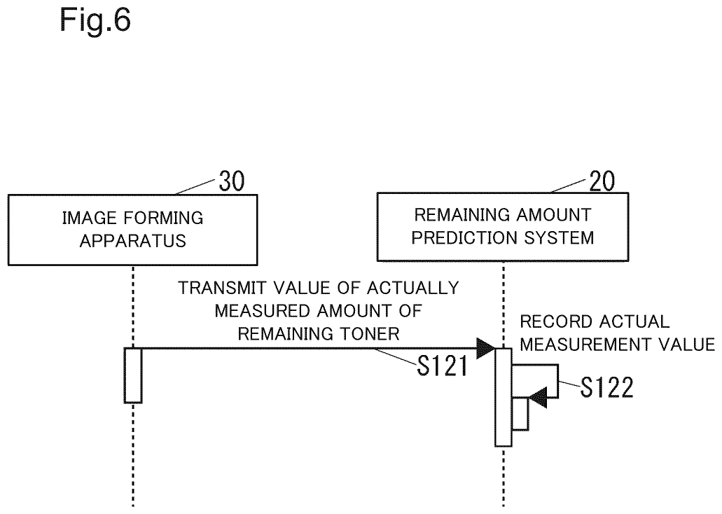

Next, operations of the system 10 in a case where the remaining amount prediction system 20 records a value of actually measured amount of toner remaining in the image forming apparatus 30 will be described. FIG. 6 is a sequence diagram illustrating operations of the system 10 in the case where the remaining amount prediction system 20 records a value of actually measured amount of toner remaining in the image forming apparatus 30.

As illustrated in FIG. 6, the image forming apparatus 30 transmits values of remaining toner actually measured every day to the remaining amount prediction system 20 via the communication device 36 (Step S121). For example, the image forming apparatus 30 transmits the latest actual measurement value from among the amounts of remaining toner detected by the remaining amount sensor 34 before the end timing of the previous day to the remaining amount prediction system 20 via the communication device 36 after the end of every day.

Once the remaining amount predictor 25A of the remaining amount prediction system 20 receives the value of actually measured amount of remaining toner transmitted from the image forming apparatus 30 via the communication device 23, the remaining amount predictor 25A records the received actual measurement value in the actual measurement value data 24C of the image forming apparatus 30 (Step S122).

The operations of the remaining amount prediction system 20 in the case where the value of actually measured amount of toner remaining in the image forming apparatus 30 is recorded have been described above. The same applies to operations of the remaining amount prediction system 20 in a case where a value of actually measured amount of toner remaining in another image forming apparatus 30 other than the image forming apparatus 30 is recorded.

Next, operations of the remaining amount prediction system 20 in a case where an empty day when the amount of toner remaining in the image forming apparatus 30 reaches 0%, that is, the amount becomes empty is predicted will be described.

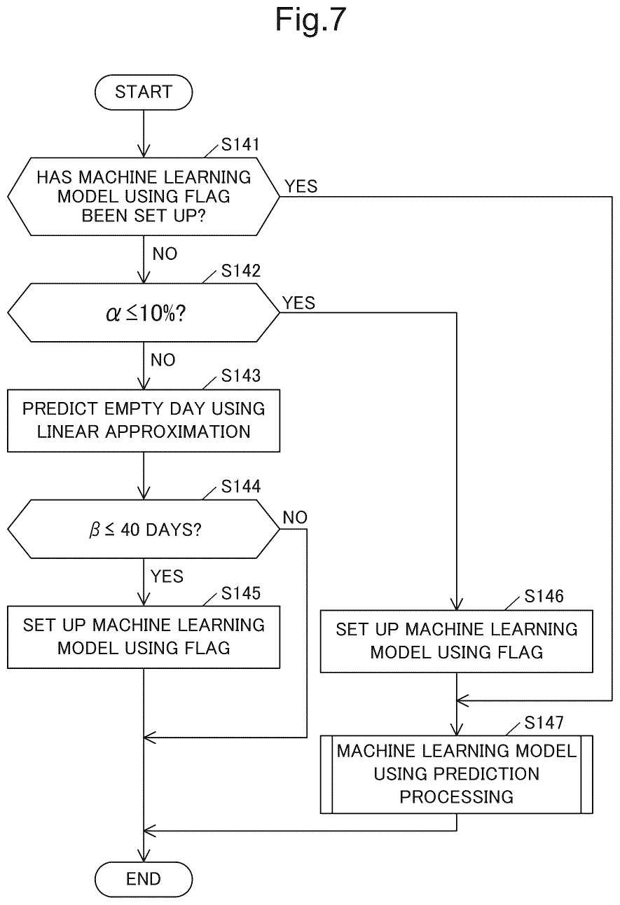

FIG. 7 is a flowchart illustrating an example of operations of the remaining amount prediction system 20 in a case where a toner empty day of the image forming apparatus 30 is predicted.

As illustrated in FIG. 7, the remaining amount predictor 25A determines whether or not the machine learning model using flag has been set up (Step S141).

If the remaining amount predictor 25A determines that the machine learning model using flag has not been set up (NO in Step S141), the remaining amount predictor 25A determines whether or not the amount α of toner remaining on the latest date from among the amounts of toner remaining on the days indicated by the actual measurement value data 24C is equal to or less than 10% as a specific remaining amount (Step S142).

If the remaining amount predictor 25A determines that the amount α of toner remaining on the latest date is not equal to or less than 10%, that is, if the remaining amount predictor 25A determines that the amount α exceeds 10% (NO in Step S142), the remaining amount predictor 25A predicts the empty day using linear approximation (Step S143).

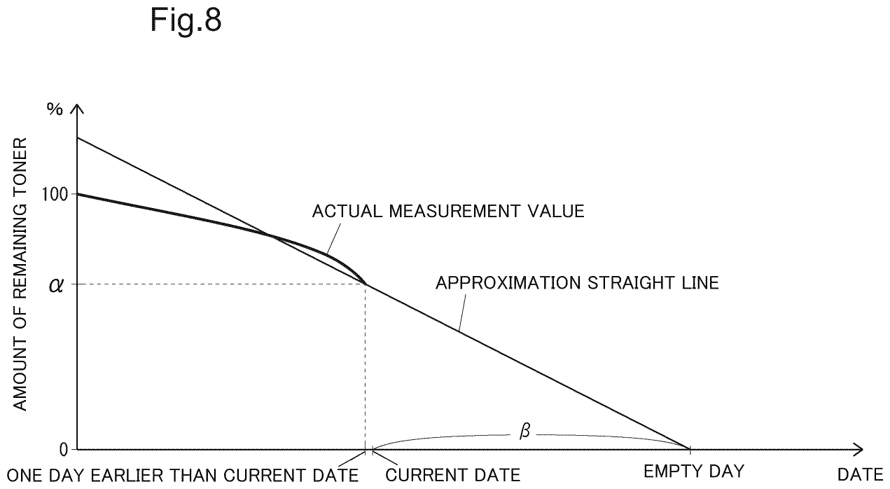

FIG. 8 is an explanatory diagram of a method of predicting the empty day using linear approximation.

As illustrated in FIG. 8, the remaining amount predictor 25A calculates an inclination in a case where the date is represented by a horizontal axis and the amount of remaining toner is represented by a vertical axis on the basis of the amounts of remaining toner for ninety days from ninety days to one day earlier than the current date from among the amounts of toner remaining on the days indicated by the actual measurement value data 24C. The remaining amount predictor 25A draws an approximation straight line of the calculated inclination such that the line passes through the amount of toner remaining one day earlier than the current date and determines the date on which the amount of remaining toner is predicted to become equal to or less than 0% on the approximation straight line as the empty day.

Note that the remaining amount predictor 25A draws an approximation straight line on the basis of the amounts of remaining toner for less than ninety days from among the amounts of remaining toner for ninety days from the ninety days to one day earlier than the current date in a case where only the amounts of remaining toner for less than ninety days from among the amounts of remaining toner for ninety days from ninety days to one day earlier than the current date are present in the actual measurement value data 24C.

As illustrated in FIG. 7, once the processing in Step S143 ends, the remaining amount predictor 25A determines whether or not the number β of days from the current date to the day predicted in Step S143 is equal to or less than 40 days (Step S144).

If the remaining amount predictor 25A determines that the number β of days is equal to or less than 40 days (YES in Step S144), the remaining amount predictor 25A sets up the machine learning model using flag (Step S145).

If the remaining amount predictor 25A determines that the amount α of toner remaining on the latest date from among the amounts of toner remaining on the days indicated by the actual measurement value data 24C is equal to or less than 10% (YES in Step S142), the remaining amount predictor 25A sets up the machine learning model using flag (Step S146).

Once the remaining amount predictor 25A determines that the machine learning model using flag has been set up (YES in S141) or ends the processing in Step S146, the remaining amount predictor 25A executes machine learning model using prediction processing of predicting the amount of remaining toner using the machine learning model (Step S147).

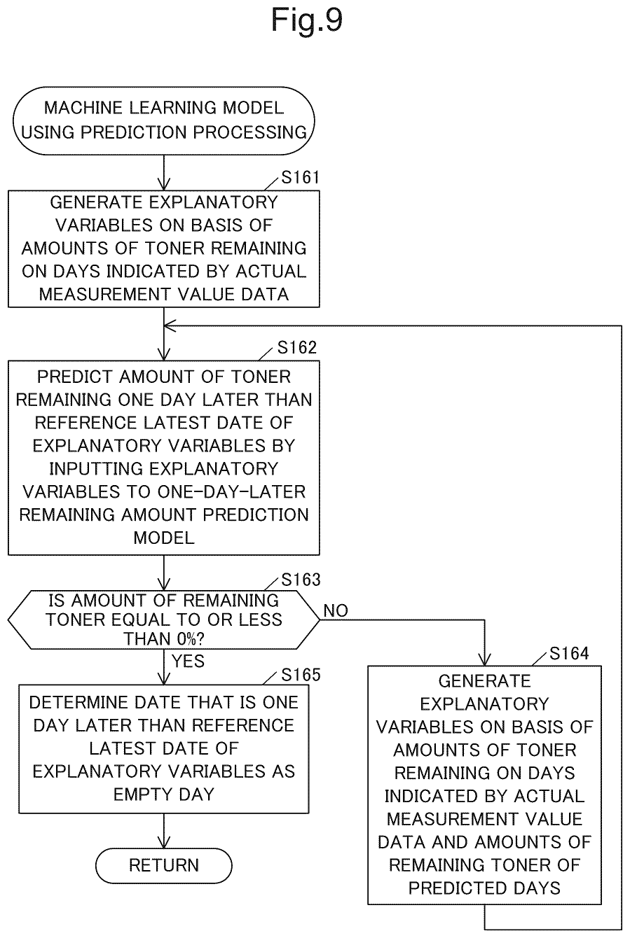

FIG. 9 is a flowchart illustrating the machine learning model using prediction processing illustrated in FIG. 7.

As illustrated in FIG. 9, the remaining amount predictor 25A generates explanatory variables of the one-day-later remaining amount prediction model 24B on the basis of the amount of toner remaining on each day indicated by the actual measurement value data 24C (S161).

Once the processing in Step S161 is ended, the remaining amount predictor 25A predicts the amount of toner remaining one day later than the reference latest date of the explanatory variable generated immediately before by inputting the explanatory variable generated immediately before to the one-day-later remaining amount prediction model 24B (Step S162).

Once the processing in Step S162 is ended, the remaining amount predictor 25A determines whether or not the amount of remaining toner predicted immediately before is equal to or less than 0% (Step S163).

If the remaining amount predictor 25A determines that the amount of remaining toner predicted immediately before is not equal to or less than 0% (NO in Step S163), the remaining amount predictor 25A generates explanatory variables of the one-day-later remaining amount prediction model 24B on the basis of the amount of toner remaining on each day indicated by the actual measurement value data 24C and the amounts of toner remaining on all the days predicted in Step S162 in the machine learning model using prediction processing illustrated in FIG. 9 (Step S164) and executes the processing in Step S162.

If the remaining amount predictor 25A determines that the amount of remaining toner predicted immediately before is equal to or less than 0% (YES in Step S163), the remaining amount predictor 25A determines the date that is one day later than the reference latest date of the explanatory variable generated immediately before as the toner empty day (Step S165) and ends the machine learning model using prediction processing.

As illustrated in FIG. 7, if the remaining amount predictor 25A determines that the number β of days from the current date to the day predicted in Step S143 is not equal to or less than forty days, that is, exceeds forty days (NO in Step S144) or if the remaining amount predictor 25A ends the processing in Step S145 or Step S147, the remaining amount predictor 25A ends the operations illustrated in FIG. 7.

Incidentally, in a remaining amount prediction system in the related art, the amounts of remaining consumable product on later dates from among amounts of remaining consumable product during one or more days as basis of explanatory variables have more influences on prediction of the amounts remaining consumable product due to the nature of the machine learning model. Therefore, there is a problem that a day that is extremely earlier or extremely later than the day when the amount of remaining consumable product actually becomes equal to or less than a specific amount may be predicted as the day when the amount of remaining consumable product will become equal to or less than the specific amount depending on content of the amounts of remaining consumable product during one or more days as basis of the explanatory variables.

On the contrary, according to the above embodiment, the remaining amount prediction system 20 switches the prediction method of predicting the empty day on the basis of the amount of actually remaining toner from the linear approximation using method using linear approximation (Step S143) to the machine learning model using method using the machine learning model (Step S147) in the process in which the amount of actually remaining toner decreases (YES in Step S142, YES in Step S146 or Step S144, and Step S145).

Therefore, it is possible to reduce the likelihood that the empty day is predicted by the machine learning model using method at the timing when the number of days from the current date to the empty day is relatively large. As a result, it is possible to improve the accuracy level of prediction of the empty day.

Also, the remaining amount prediction system 20 can increase the likelihood that the empty day is predicted by the linear approximation using method that is less likely to take time for the prediction processing than the machine learning model using method instead of the machine learning model using method that takes time for the prediction processing at the timing when the number of days from the current date to the empty day is relatively large and can thus shorten the time for the prediction processing.

Also, according to the above embodiment, the remaining amount prediction system 20 switches the prediction method from the linear approximation using method to the machine learning model using method (Step S145) in a case where the number β of days from the current date to the empty day predicted using the linear approximation is equal to or less than forty days (YES in Step S144). Therefore, it is possible to reduce the likelihood that the empty day is predicted by the machine learning model using method at the timing when the number of days from the current date to the empty day is relatively large.

Also, according to the above embodiment, the remaining amount prediction system 20 switches the prediction method from the linear approximation using method to the machine learning model using method (Step S146) in a case where the amount α of actually remaining toner is equal to or less than 10% (YES in Step S142). Therefore, it is possible to increase the likelihood that the empty day is predicted by the machine learning model using method in a case where the linear approximation using method is not appropriate, such as a case where the amount of actually remaining toner has decreased and cannot be appropriately detected by the remaining amount sensor 34.

### Modification Examples

In the above embodiment, the remaining amount prediction system 20 switches the prediction method from the linear approximation using method to the machine learning model using method (Step S146) in the case where the amount x of actually remaining toner is equal to or less than 10% (YES in Step S142). Since the lower limit of detection performed by the remaining amount sensor 34 is 5%, 10% as a reference of the determination in Step S142 is set as a value that is equal to or greater than 5%. However, the reference of the determination in Step S142 may be a value other than 10% as long as the value is equal to or greater than the lower limit of the detection performed by the remaining amount sensor 34.

In the above embodiment, the remaining amount prediction system 20 switches the prediction method from the linear approximation using method to the machine learning model using method on the basis of the amount α of toner remaining on the latest date from among the amounts of toner remaining on the days indicated by the actual measurement value data 24C (YES in Step S142 and Step S146).

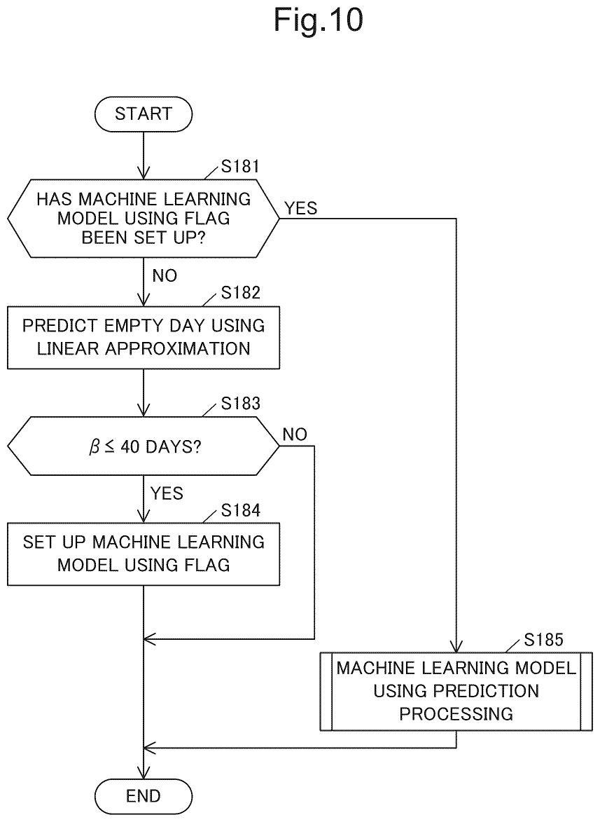

However, the remaining amount prediction system 20 may not switch the prediction method from the linear approximation using method to the machine learning model using method on the basis of the amount α of toner remaining on the latest date from among the amounts of toner remaining on the days indicated by the actual measurement value data 24C. For example, the remaining amount prediction system 20 may execute operations illustrated in FIG. 10 instead of the operations illustrated in FIG. 7.

FIG. 10 is a flowchart illustrating an example that is different from the example illustrated in FIG. 7 for operations of the remaining amount prediction system 20 in a case where the toner empty day in the image forming apparatus 30 is predicted.

As illustrated in FIG. 10, the remaining amount predictor 25A executes processing in Step S181 that is similar to the processing in Step S141 illustrated in FIG. 7.

If the remaining amount predictor 25A determines that the machine learning model using flag has not been set up (NO in Step S181), the remaining amount predictor 25A executes processing in Step S182 to Step S184 that are similar to the processing in

Step S143 to Step S145 illustrated in FIG. 7 and ends the operations illustrated in FIG. 10.

If the remaining amount predictor 25A determines that the machine learning model using flag has set up (YES in Step S181), the remaining amount predictor 25A executes processing in Step S185 that is similar to the processing in Step S147 illustrated in FIG. 7 and ends the operations illustrated in FIG. 10.

In the above embodiment, the remaining amount prediction system 20 switches the prediction method from the linear approximation using method to the machine learning model using method (YES in Step S144 and Step S145, or YES in Step S183 and Step S184) in a case where the number β of days from the current date to the empty day predicted using linear approximation is equal to or less than forty days. However, the reference of the determination in Step S144 or Step S183 may be a value other than forty days.

In the above embodiment, the remaining amount prediction system 20 calculates the inclination of the approximation straight line on the basis of the amounts of remaining toner for ninety days from ninety days to one day earlier than the current data from among the amounts of toner remaining on the days indicated by the actual measurement value data 24C. However, the present disclosure is not limited to such an embodiment. For example, the remaining amount prediction system 20 may calculate the inclination of the approximation straight line on the basis of the amounts of remaining toner for forty five days from forty five days to one day earlier than the current date from among the amounts of toner remaining on the days indicated by the actual measurement value data 24C.

In the above embodiment, the remaining amount prediction system 20 generates the explanatory variables of the machine learning model on the basis of the nine types of amounts of remaining toner, namely the amount of toner remaining on the reference latest date, the amount of toner remaining one day earlier than the reference latest date, the amount of toner remaining two days earlier than the reference latest date, the amount of toner remaining three days earlier than the reference latest date, the amount of toner remaining four days earlier than the reference latest date, the amount of toner remaining five days earlier than the reference latest date, the amount of toner remaining six days earlier than the reference latest date, the amount of toner remaining thirteen days earlier than the reference latest date, and the amount of toner remaining eighty nine days earlier than the reference latest date from among the amounts of toner remaining on the days indicated by the actual measurement value data 24C (Step S161 and Step S164). However, the remaining amount prediction system 20 may generate the explanatory variables of the machine learning model on the basis of the amounts of remaining toner other than the aforementioned nine types of amounts of remaining toner from among the amounts of toner remaining on the days indicated by the actual measurement value data 24C.

In the above embodiment, the remaining amount prediction system 20 predicts the empty day when the amount of remaining consumable product will become 0%. However, the remaining amount prediction system 20 may predict the day when the amount of remaining consumable product will become equal to or less than a specific amount other than 0% as the empty day.

In the above embodiment, the consumable product in the present disclosure is a toner used in the image forming apparatus 30. However, the consumable product in the present disclosure may be a consumable product other than the toner used in the image forming apparatus 30 or may be a consumable product used in an electronic device other than the image forming apparatus 30.

While the present disclosure has been described in detail with reference to the embodiments thereof, it would be apparent to those skilled in the art the various changes and modifications may be made therein within the scope defined by the appended claims.

What is claimed is:

1. A remaining amount prediction system comprising:
a storage device that stores actual measurement value data indicating an amount of actually remaining consumable product used in an electronic device; and
a controller that includes a processor and functions as a remaining amount predictor that predicts an empty day when the amount of remaining consumable product will become equal to or less than a specific amount on the basis of the amount actually remaining consumable product by the processor executing a remaining amount prediction program,
wherein the remaining amount predictor switches a prediction method to be used to predict the empty day from a linear approximation using method using linear approximation to a machine learning model using method using a machine learning model in a process in which the amount of actually remaining consumable product decreases.

2. The remaining amount prediction system according to claim 1, wherein the remaining amount predictor switches the prediction method from the linear approximation using method to the machine learning model using method in a case where the number of days from the current date to the empty day predicted using the linear approximation is equal to or less than a specific number of days, and maintains the linear approximation using method as the prediction method in a case where the number of days until the empty day exceeds the specific number of days.

3. The remaining amount prediction system according to claim 2, wherein the remaining amount predictor switches the prediction method from the linear approximation using method to the machine learning model using method in a case where the amount of actually remaining consumable product is equal to or less than a specific remaining amount, and maintains the linear approximation using method as the prediction method in a case where the amount of actually remaining consumable product exceeds the specific remaining amount.

4. The remaining amount prediction system according to claim 3,
wherein the storage device stores the actual measurement value data indicating values of amounts of toner remaining in an image forming apparatus as the electronic device actually measured every day, and
the remaining amount predictor switches the prediction method in a case where the amount of remaining toner indicated by the latest actual measurement value out of the values actually measured every day is equal to or less than a specific remaining amount, and does not switch the prediction method in a case where the amount of remaining toner indicated by the latest actual measurement value exceeds the specific remaining amount.

5. A computer-readable non-transitory recording medium that stores a remaining amount prediction program,
wherein the remaining amount prediction program causes a computer including a processor and a storage device that stores actual measurement value data indicating an amount of actually remaining consumable product used in an electronic device to function as a remaining amount predictor that predicts an empty day when the amount of remaining consumable product will become equal to or less than a specific amount on the basis of the amount of actually remaining consumable product by the processor executing the remaining amount prediction program, and
the remaining amount predictor switches a prediction method to be used to predict the empty day from a linear approximation using method using linear approximation to a machine learning model using method using a machine learning model in a process in which the amount of actually remaining consumable product decreases.
